(19) United States
(12) Patent Application Publication
(10) Pub. No.: US 2015/0120988 A1
(43) Pub. Date: Apr. 30, 2015

(54) Method of Accessing Data in Multi-Layer Cell Memory and Multi-Layer Cell Storage Device Using the Same

(71) Applicant: Skymedi Corporation, Hsinchu (TW)

(72) Inventors: Chiun-Luen Hung, Hsinchu (TW); Yi-Chun Liu, Hsinchu (TW)

(73) Assignee: Skymedi Corporation, Hsinchu (TW)

(21) Appl. No.: 14/064,205

(22) Filed: Oct. 28, 2013

(51) Int. Cl. G06F 12/02

(52) U.S. Cl. CPC G06F 12/0246; G06F 2212/7201
USPC 711/103

(57) ABSTRACT

A method of accessing data in a multi-layer cell (MLC) memory includes using single-layer cell (SLC) configuration to transfer a portion of a plurality of memory units in the MLC memory to an SLC area to form a plurality of MLC memory units and a plurality of SLC memory units; storing data in the plurality of SLC memory units when the data is assigned to be stored in an MLC memory unit; mapping the MLC memory unit to the SLC memory units; reading the data by obtaining the data in the SLC memory units corresponding to the MLC memory unit; and reallocating the SLC memory units to use MLC configuration when an update of data is involved in the MLC memory unit or a new data is assigned to be stored in at least one of the SLC memory units.

### BACKGROUND OF THE INVENTION

1. Field of the Invention

The present invention relates to a method of accessing data in a multi-layer cell (MLC) memory and an MLC storage device using the same, and more particularly, to a method of accessing data in an MLC memory and an MLC storage device capable of enhancing the reliability of data stored in the MLC storage device.

2. Description of the Prior Art

A memory controller is commonly utilized for task management in a memory system, especially in a non-volatile memory system. In general, since data stored in a non-volatile memory system may not be lost after electric power of the non-volatile memory system is cut off, the non-volatile memory system becomes an important means for storing system data. Among those non-volatile memory systems, NAND flash memory, which has advantages of low power and high speed, becomes popular with the popularization of portable devices in recent years.

The NAND flash memory stores data in individual memory cells, which are composed of floating-gate transistors. Traditionally, each memory cell has two possible states, so one bit of data is stored in each cell, which makes up a so-called single-level cell (SLC) flash memory. The SLC memory has the advantage of higher write speed, lower power consumption and higher cell endurance. Since the SLC flash memory stores only one data per cell, it costs more to manufacture a unit of storage space. In order to reduce the cost, NAND flash vendors are constantly pushed to increase storage density. A multi-layer cell (MLC) flash memory is therefore generated. The “MLC” refers to a memory element capable of storing more than one single bit of data. The MLC flash is a flash memory technology using multiple levels per cell to allow more bits to be stored using the same number of transistors. In the SLC flash technology, each cell can exist in one of two states, storing one bit of data per cell. In comparison, the MLC flash memory has more than four possible states per cell, so it can store more than two bits of data per cell. Due to the higher data density of the MLC flash memory, it can enjoy the benefit of lower cost per bit of stored data.

The MLC flash technology, however, reduces the amount of margin separating the states, which results in the increased possibility of errors, especially in a severe environment such as high temperature. In the mass production flow of the MLC flash memory, there is usually pre-written data stored in the flash memory before the memory chip is soldered on the circuit board. If the pre-written data is written via MLC technology, it will easily be damaged under high temperature during the soldering process. Even if an SLC buffer exists in the MLC flash memory, the SLC buffer space is usually too small to store the pre-written data; hence the user area of the MLC flash memory has to be occupied by the pre-written data in MLC configuration, which leads to a higher probability of data loss in the soldering process. Thus, there is a need for improvement over the prior art.

### SUMMARY OF THE INVENTION

It is therefore an objective of the present invention to provide a method of accessing data in a multi-layer cell (MLC) memory and an MLC storage device using the same capable of enhancing the reliability of data stored in the MLC storage device by storing data in the MLC storage device in single-layer cell (SLC) configuration, and reallocating the SLC areas to use MLC configuration when an update is involved in the data.

The present invention discloses a method of accessing data in a MLC memory. The method comprises using SLC configuration to transfer a portion of a plurality of memory units in the MLC memory to an SLC area to form a plurality of MLC memory units and a plurality of SLC memory units; storing data in the plurality of SLC memory units when the data is assigned to be stored in an MLC memory unit; mapping the MLC memory unit to the SLC memory units; reading the data by obtaining the data in the SLC memory units corresponding to the MLC memory unit; and reallocating the SLC memory units to use MLC configuration when an update of data is involved in the MLC memory unit or a new data is assigned to be stored in at least one of the SLC memory units.

The present invention further discloses an MLC storage device. The MLC storage device comprises an MLC memory, comprising a plurality of memory units; and a memory controller, coupled to the MLC memory. The memory controller is utilized for accessing data in the MLC memory by executing the following steps: using SLC configuration to transfer a portion of the plurality of memory units in the MLC memory to an SLC area to form a plurality of MLC memory units and a plurality of SLC memory units; storing data in the plurality of SLC memory units when the data is assigned to be stored in an MLC memory unit; mapping the MLC memory unit to the SLC memory units; reading the data by obtaining the data in the SLC memory units corresponding to the MLC memory unit; and reallocating the SLC memory units to use MLC configuration when an update of data is involved in the MLC memory unit or a new data is assigned to be stored in at least one of the SLC memory units.

The present invention further discloses a method of accessing data in an MLC memory. The method comprises storing data in an SLC memory area by transferring a portion of an MLC memory area in the MLC memory to form the SLC memory area; moving the stored data from the SLC memory area to the MLC memory area when the SLC memory area is allocated to store a new data or an update of the stored data is involved; and transferring the SLC memory area to form the portion of MLC memory area.

The present invention further discloses an MLC storage device. The MLC storage device comprises an MLC memory, comprising an MLC memory area to store data; and a memory controller, coupled to the MLC memory. The MLC memory is utilized for managing the MLC memory by executing the following steps: storing data in an SLC memory area by transferring a portion of an MLC memory area in the MLC memory to form the SLC memory area; moving the stored data from the SLC memory area to the MLC memory area when the SLC memory area is allocated to store a new data or an update of the stored data is involved; and transferring the SLC memory area to form the portion of MLC memory area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an MLC memory according to an embodiment of the present invention.

FIG. 2A and FIG. 2B are a schematic diagram of a TLC memory according to an embodiment of the present invention.

FIG. 3 is a schematic diagram of a TLC memory according to an embodiment of the present invention.

FIG. 4 is a schematic diagram of another TLC memory according to an embodiment of the present invention.

FIG. 5 is a schematic diagram of reading pre-written data in the TLC memory.

FIG. 6 is a schematic diagram of writing data into the TLC memory unit of the TLC memory.

FIG. 7 is a schematic diagram of writing data into the SLC memory unit of the TLC memory.

FIG. 8 is a schematic diagram of an MLC memory configuring process according to an embodiment of the present invention.

FIG. 9 is a schematic diagram of a reallocation process according to an embodiment of the present invention.

FIG. 10 is a schematic diagram of a reallocation process according to an embodiment of the present invention.

### DETAILED DESCRIPTION

As mentioned above, in a multi-layer cell (MLC) memory, it is desirable to use single-layer cell (SLC) configuration to store data rather than use MLC configuration. As a result, an arrangement for storing data in MLC memory will be necessary.

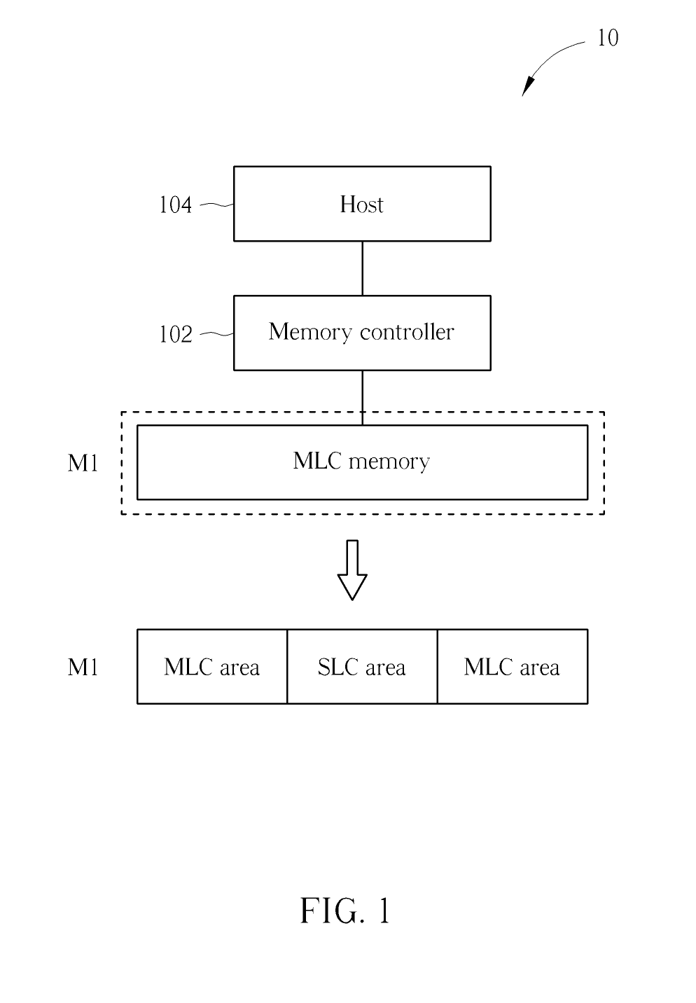

Please refer to FIG. 1, which is a schematic diagram of an MLC storage device 10 according to an embodiment of the present invention. The MLC storage device 10 includes a memory controller 102 and a MLC memory M1. The MLC memory M1 includes a plurality of memory units for storing data. When data is stored in the MLC memory M1, several of the memory units in the MLC memory M1 may be transferred to use SLC configuration; hence the MLC memory M1 may include an MLC area and an SLC area, as shown in FIG. 1. For example, an MLC memory with N-bit per cell configuration may include N SLC areas. The controller 102, coupled to the MLC memory M1, is utilized for accessing data in the MLC memory M1. In general, the MLC storage device 10 is managed by a host 104, as shown in FIG. 1.

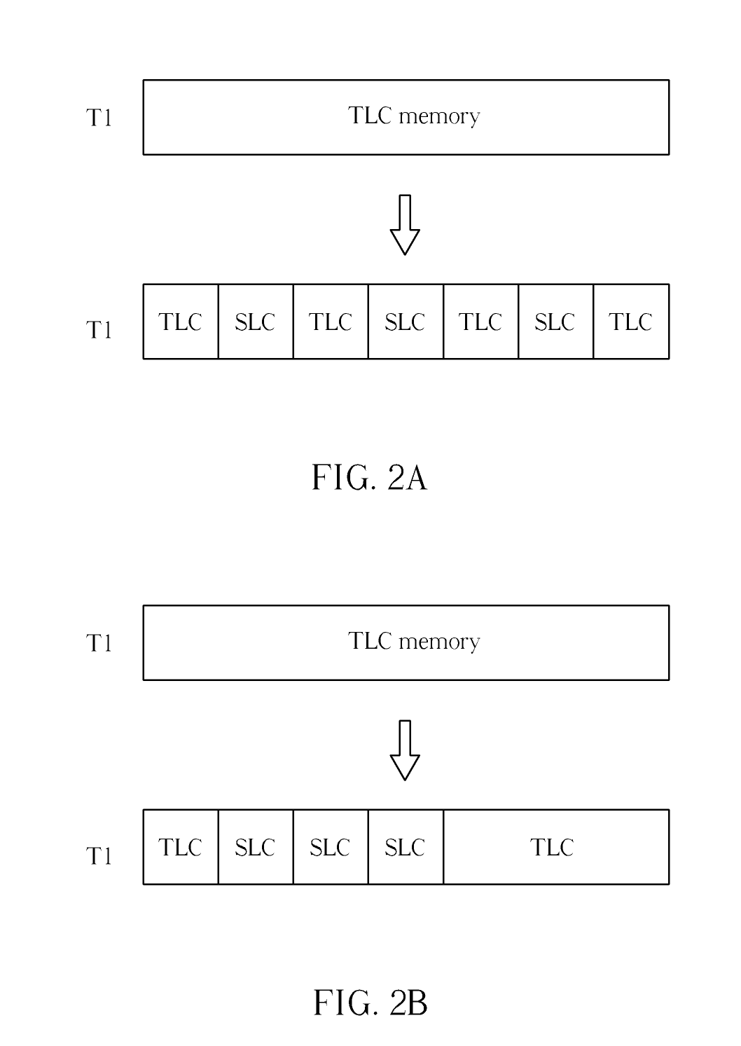

Please refer to FIG. 2A and FIG. 2B, which are schematic diagrams of a triple-level cell (TLC) memory T1 according to an embodiment of the present invention. As shown in FIG. 2A and FIG. 2B, in the TLC memory T1, three bits of data are stored per cell; hence there may be three SLC areas allocated in the TLC memory T1 for storing the data. The arrangement of the TLC areas and the SLC areas can be arbitrarily determined. For example, three SLC areas can be distributed over the TLC memory T1, as shown in FIG. 2A. These three SLC areas may also be gathered together in the TLC memory T1, as shown in FIG. 2B. In general, the arrangement of the TLC areas and the SLC areas may be determined according to the size of the stored data. If more data needs to be stored in the TLC memory T1, larger SLC areas will be required.

Please note that the above arrangement of the SLC areas for the MLC memory is utilized for storing the pre-soldering data, in order to prevent the pre-soldering data from being lost due to the high temperature during the soldering process. Since the SLC configuration has higher reliability than the MLC configuration does, data with higher importance or data requiring higher reliability may also be allocated to use SLC configuration, which should not be limited to the pre-soldering data. Such data will be named pre-written data herein.

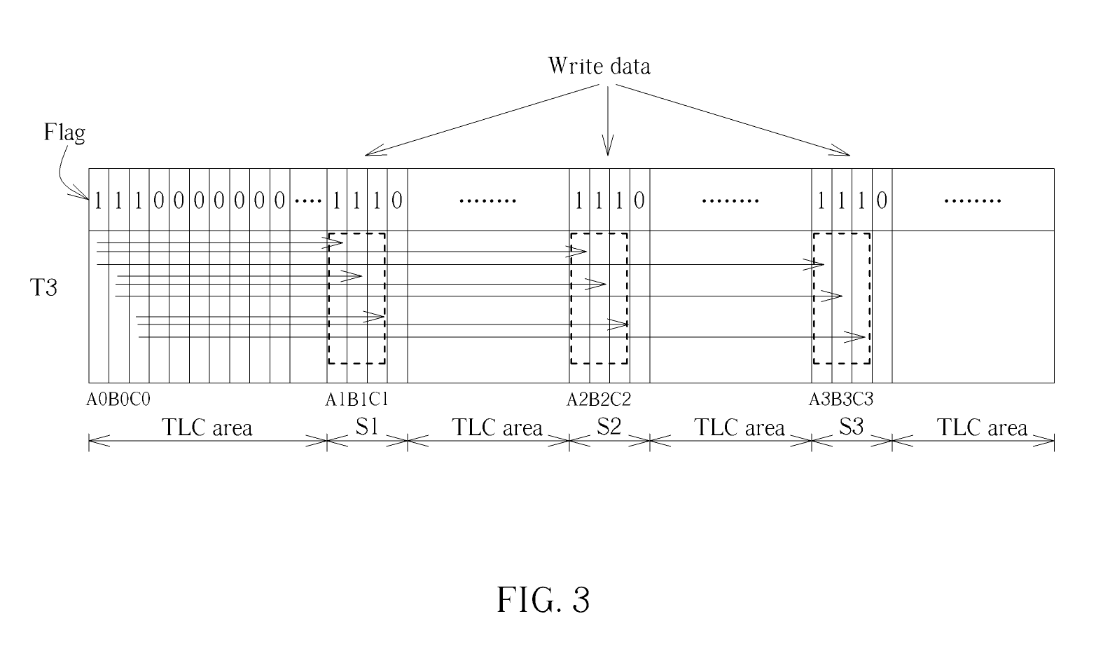

Please refer to FIG. 3, which is a schematic diagram of a TLC memory T3 according to an embodiment of the present invention. The TLC memory T3 includes three SLC areas S1-S3 arranged in the same way as FIG. 2A shows. In this embodiment, the memory controller needs to write 9 units of pre-written data in the TLC memory T3. The memory controller first allocates 3 TLC memory units A0, B0 and C0 in a TLC area for these 9 units of pre-written data, where each TLC memory unit has a capacity of 3 units of data. The memory units A0, B0 and C0 are mapping to SLC memory units A1-A3, B1-B3 and C1-C3, respectively, where the SLC memory units A1, B1 and C1 are located in the SLC area S1, the SLC memory units A2, B2 and C2 are located in the SLC area S2, and the SLC memory units A3, B3 and C3 are located in the SLC area S3. The 9 units of pre-written data are not stored in the TLC memory units A0, B0 and C0 actually; instead, they will be stored in the SLC memory units A1-A3, B1-B3 and C1-C3, where 9 SLC memory units can exactly store 9 units of data. More specifically, the host may suppose that these pre-written data are stored in the TLC memory units, but the data are actually stored in the SLC memory units which correspond to the TLC memory units.

The memory controller may set a flag for indicating whether there is pre-written data stored in the memory units. As shown in FIG. 3, in the TLC area, the TLC memory units A0, B0 and C0 are allocated for the pre-written data, and the corresponding flags are set to 1; the flags for other TLC memory units are set to 0. In the SLC areas S1-S3, the SLC memory units A1-A3, B1-B3 and C1-C3 are mapping to the TLC units A0, B0 and C0 respectively and store the pre-written data, and the corresponding flags are set to 1; the flags for other SLC memory units are set to 0. In other words, if a flag corresponding to a memory unit is set to 1, the memory unit (SLC memory unit or TLC memory unit) is considered to be involved in the storage of pre-written data. In addition, the memory controller has to use a mapping table for recording the mapping between the TLC memory units and the SLC memory units. The implementations of the mapping table should be well-known in the art, and will not be narrated herein.

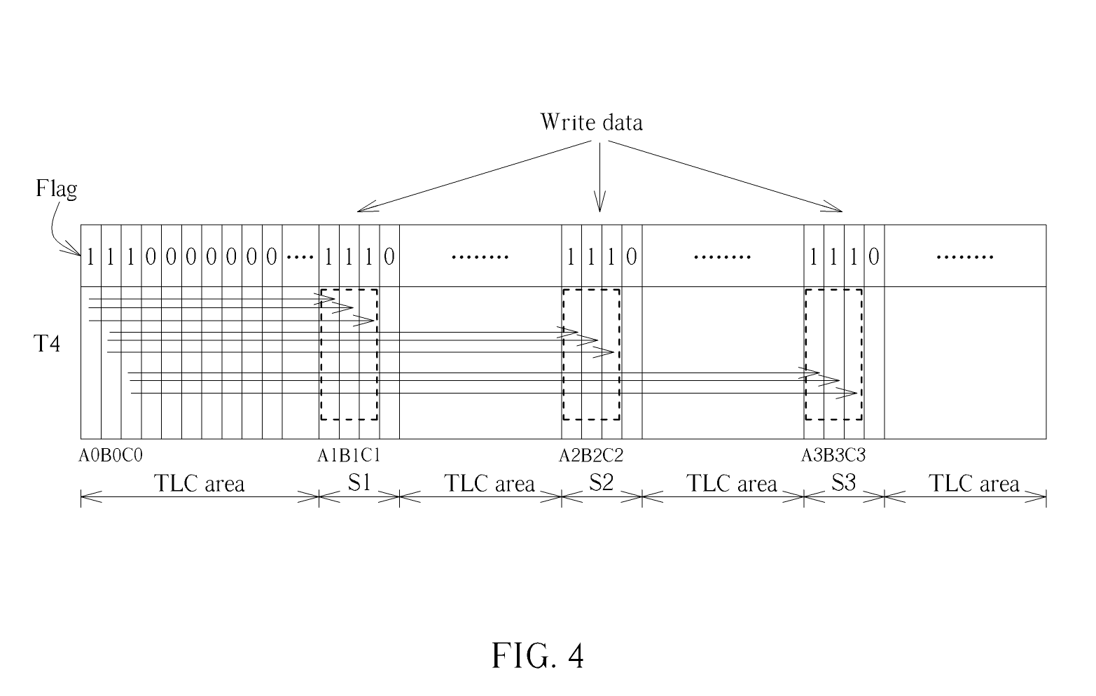

Please note that, the mapping relationship between the TLC memory units in the TLC area and the SLC memory units in the SLC areas may be arbitrarily determined. For example, please refer to FIG. 4, which is a schematic diagram of another TLC memory T4 according to an embodiment of the present invention. As shown in FIG. 4, the memory unit A0 is mapping to the SLC memory units A1, B1 and C1, the memory unit B0 is mapping to the SLC memory units A2, B2 and C2, and the memory unit C0 is mapping to the SLC memory units A3, B3 and C3. The difference between the TLC memory T4 and the TLC memory T3 is that the arrangement of SLC memory units in the SLC areas of the TLC memory T4 is different from that of the TLC memory T3.

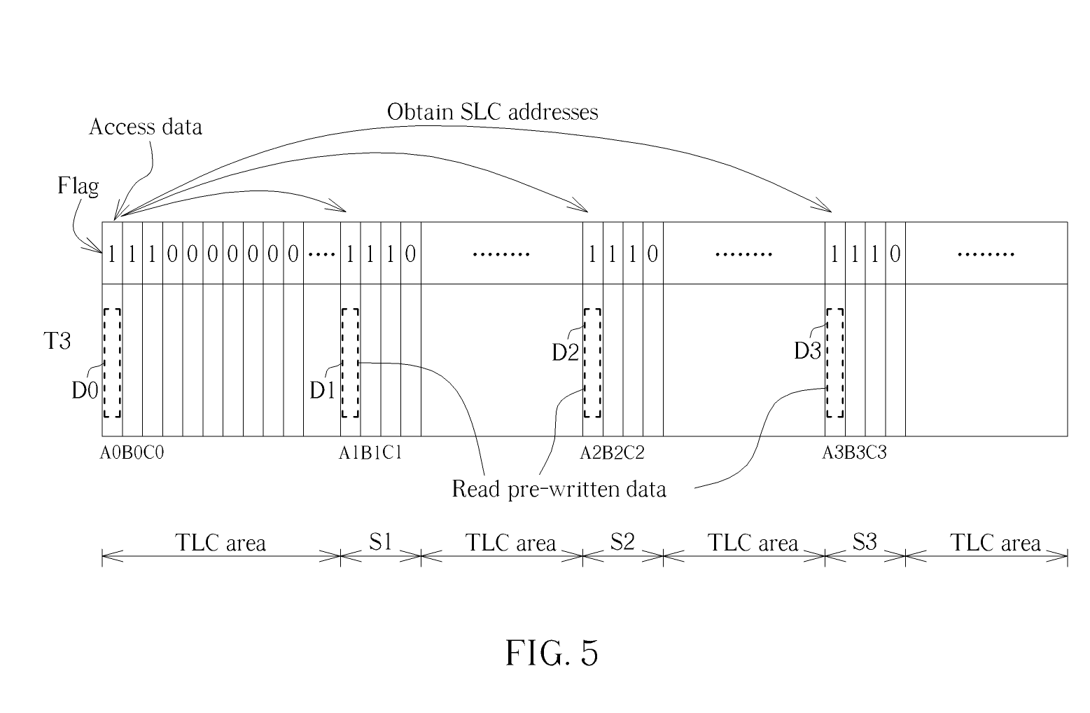

Please refer to FIG. 5, which is a schematic diagram of reading pre-written data in the TLC memory T3. As shown in FIG. 5, the TLC memory unit A0 has recorded the pre-written data D0, which is divided into pre-written data D1-D3 and stored in the SLC memory units A1-A3, respectively. As mentioned above, the host may think that the pre-written data is stored in the TLC memory units; hence, when the host needs to read the pre-written data D0, the memory controller may first access the TLC memory unit A0. The memory controller then finds out that the flag indicating whether pre-written data exists in the TLC memory unit A0 is 1. In such a condition, the memory controller will obtain the addresses of the SLC memory units A1, A2 and A3 in the SLC areas according to the mapping table. The memory controller then reads the pre-written data in the SLC memory units A1, A2 and A3 and outputs them to the host.

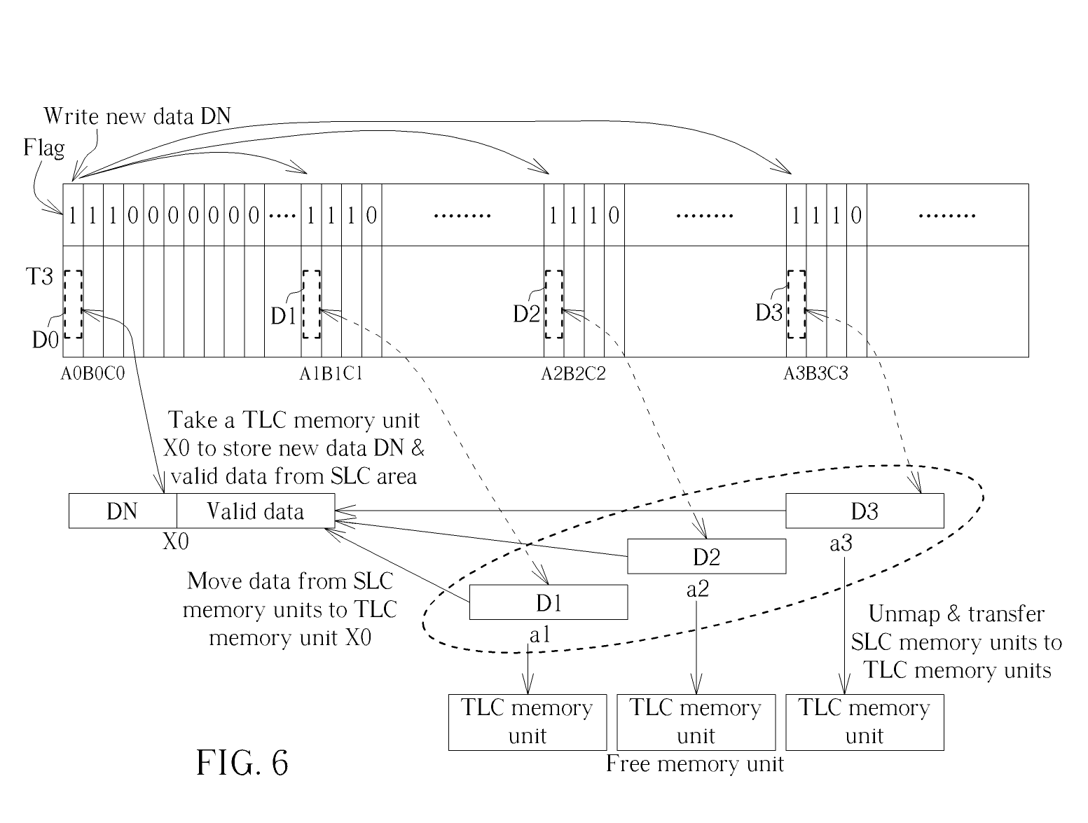

Please refer to FIG. 6, which is a schematic diagram of writing data into the TLC memory unit A0 of the TLC memory T3. As shown in FIG. 6, the TLC memory unit A0 has recorded the pre-written data D0, which is divided into pre-written data D1-D3 and stored in the SLC memory units A1-A3, respectively. When the memory controller needs to write new data DN to update the pre-written data D0 in the TLC memory unit A0, the memory controller finds out that the flag indicating whether pre-written data exists in the TLC memory unit A0 is 1 and the target memory unit A0 is in the TLC area. In such a condition, the memory controller will take a physical TLC memory unit X0 mapped to the TLC memory unit A0 to store the new data DN. If the size of the new data DN is smaller than the physical TLC memory unit X0, the other space of the physical TLC memory unit X0 is filled in valid data, which should be gathered from the SLC memory units A1-A3, respectively. In other words, the new data DN and the valid data in the SLC memory units A1-A3 are stored in the physical TLC memory unit X0. After the valid data in the SLC memory units A1-A3 are moved to the physical TLC memory unit X0, the SLC memory units A1-A3 will be unmapped. The physical SLC memory units a1-a3 originally mapped to the SLC memory units A1-A3 can then be transferred to use TLC configuration.

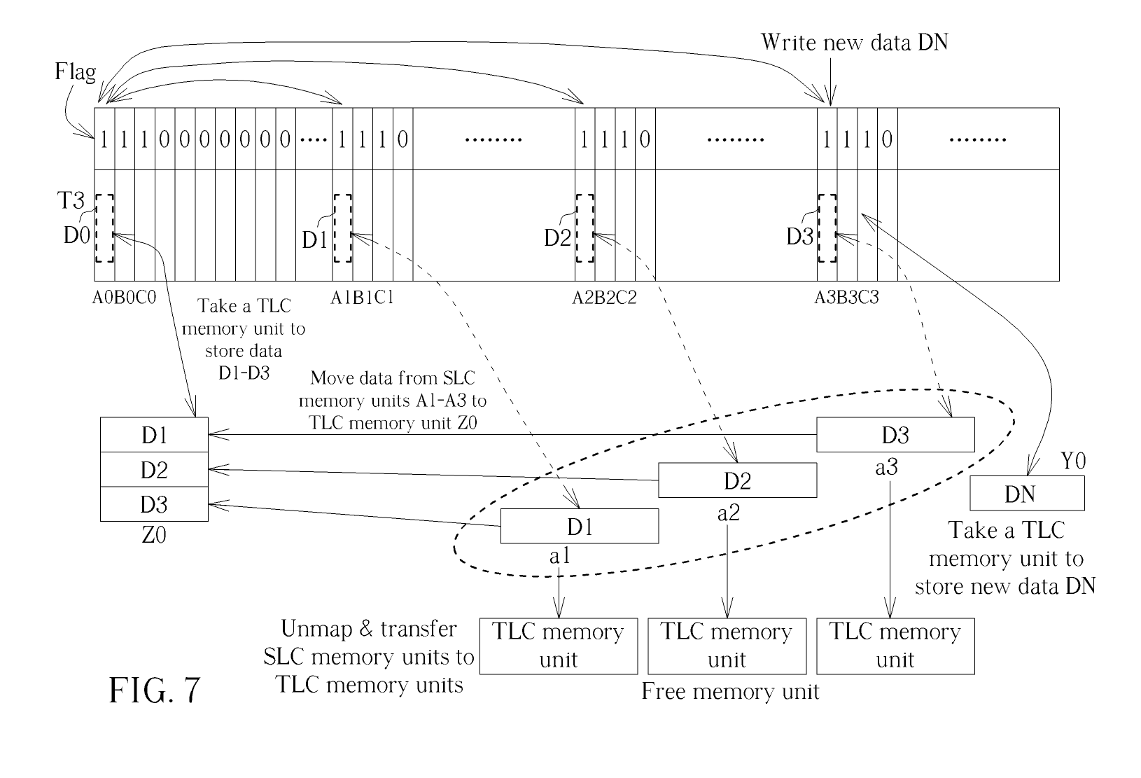

Please refer to FIG. 7, which is a schematic diagram of writing data into the SLC memory unit A3 of the TLC memory T3. As shown in FIG. 7, the TLC memory unit A0 has recorded the pre-written data D0, which is divided into pre-written data D1-D3 and stored in the SLC memory units A1-A3, respectively. When the memory controller needs to write new data DN into the SLC memory unit A3, the memory controller finds out that the flag indicating whether pre-written data exists in the TLC memory unit A0 is 1 and the target memory unit A3 is in the SLC area. In such a condition, the memory controller will take a new physical TLC memory unit Y0 to store the new data DN. A physical TLC memory unit Z0 mapped to the TLC memory unit A0 is allocated to store the pre-written data D1-D3 originally stored in the SLC memory units A1-A3. In other words, the pre-written data D1-D3 stored in the SLC memory units A1-A3 are stored in the physical TLC memory unit Z0. The new data DN is stored in the physical TLC memory unit Y0. The logical address which is originally mapping to the memory unit A3 will then be mapping to the physical TLC memory unit Y0. After the pre-written data D1-D3 are moved to the physical TLC memory unit Z0, the SLC memory units A1-A3 will be unmapped. The physical SLC memory units a1-a3 originally mapped to the SLC memory units A1-A3 can then be transferred to use TLC configuration.

Please note that the present invention provides a method for accessing data in an MLC memory and an MLC storage device by storing the pre-written data in the MLC memory in SLC configuration and reallocating the SLC areas to use MLC configuration when a data update is involved in the pre-written data, which enhances the reliability of the pre-written data without reducing the storage capacity of the MLC storage device. Those skilled in the art can make modifications and alternations accordingly. For example, the above embodiments take TLC memory as the examples, but in other embodiments, the proposed method may also be applied to other types of MLC memories with any numbers of bits of data per cell. The allocation and arrangement of the SLC areas may also be determined according to system requirements, which should not be limited herein. In addition, the abovementioned memory unit is a unit of memory used for storing a unit of data, which may be a block, a page, a cluster or any other units for storing user data.

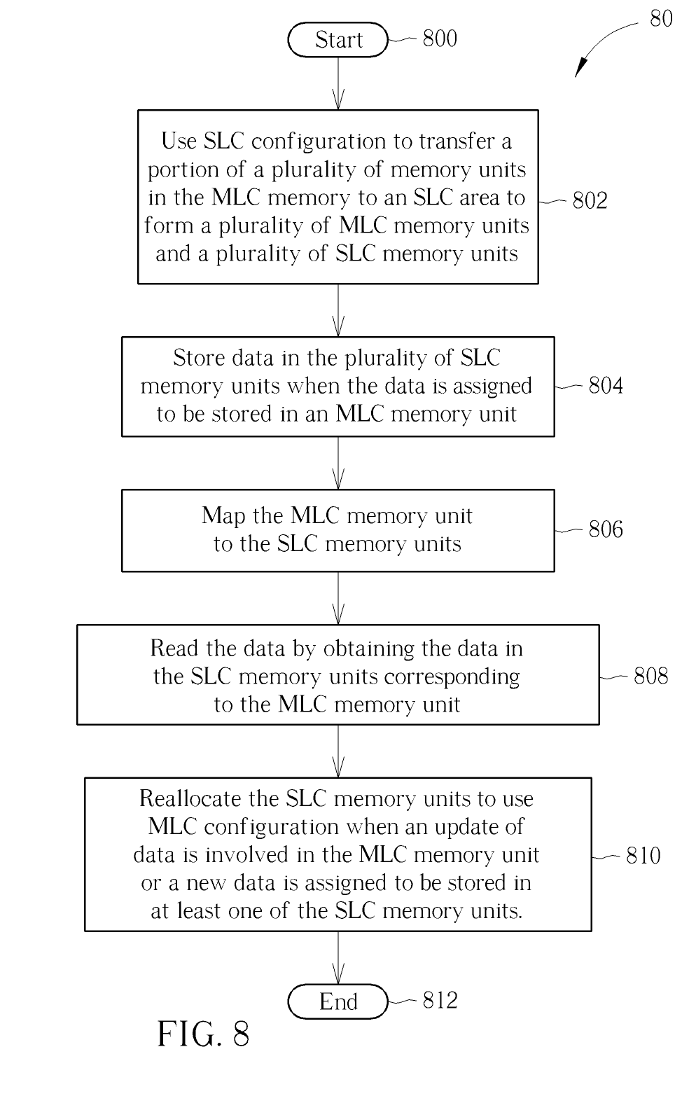

The abovementioned operations of the memory controller can be summarized into an MLC memory configuring process 80, as shown in FIG. 8. The MLC memory configuring process 80 includes the following steps:

Step 800: Start.

Step 802: Use SLC configuration to transfer a portion of a plurality of memory units in the MLC memory to an SLC area to form a plurality of MLC memory units and a plurality of SLC memory units.

Step 804: Store data in the plurality of SLC memory units when the data is assigned to be stored in an MLC memory unit.

Step 806: Map the MLC memory unit to the SLC memory units.

Step 808: Read the data by obtaining the data in the SLC memory units corresponding to the MLC memory unit.

Step 810: Reallocate the SLC memory units to use MLC configuration when an update of data is involved in the MLC memory unit or a new data is assigned to be stored in at least one of the SLC memory units.

Step 812: End.

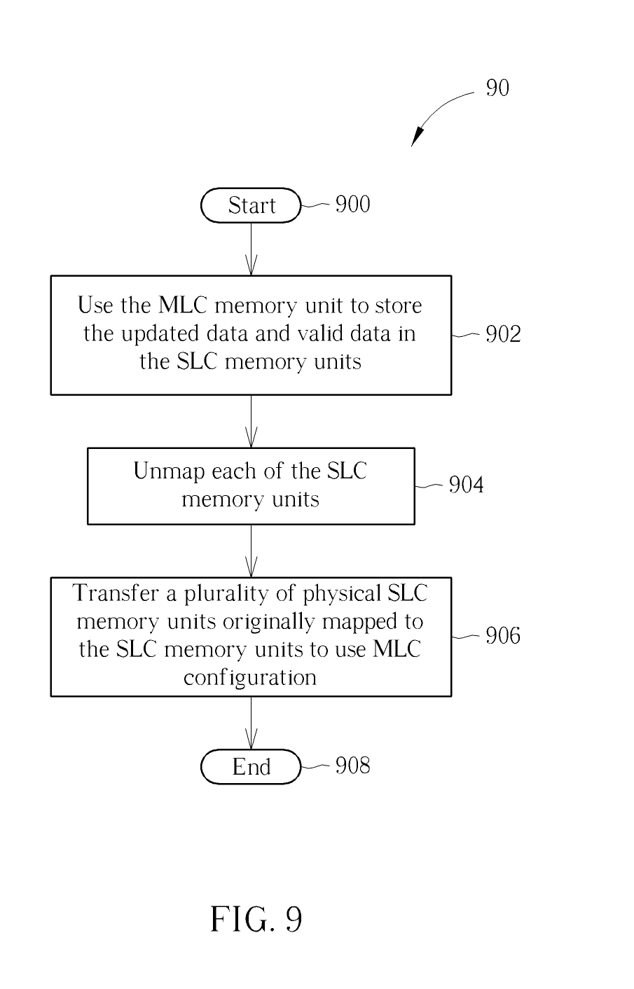

In Step 810, when the update of data is involved in the MLC memory unit, the memory controller further executes a reallocation process 90, as shown in FIG. 9. The reallocating process 90 includes the following steps:

Step 900: Start.

Step 902: Use the MLC memory unit to store the updated data and valid data in the SLC memory units.

Step 904: Unmap each of the SLC memory units.

Step 906: Transfer a plurality of physical SLC memory units originally mapped to the SLC memory units to use MLC configuration.

Step 908: End.

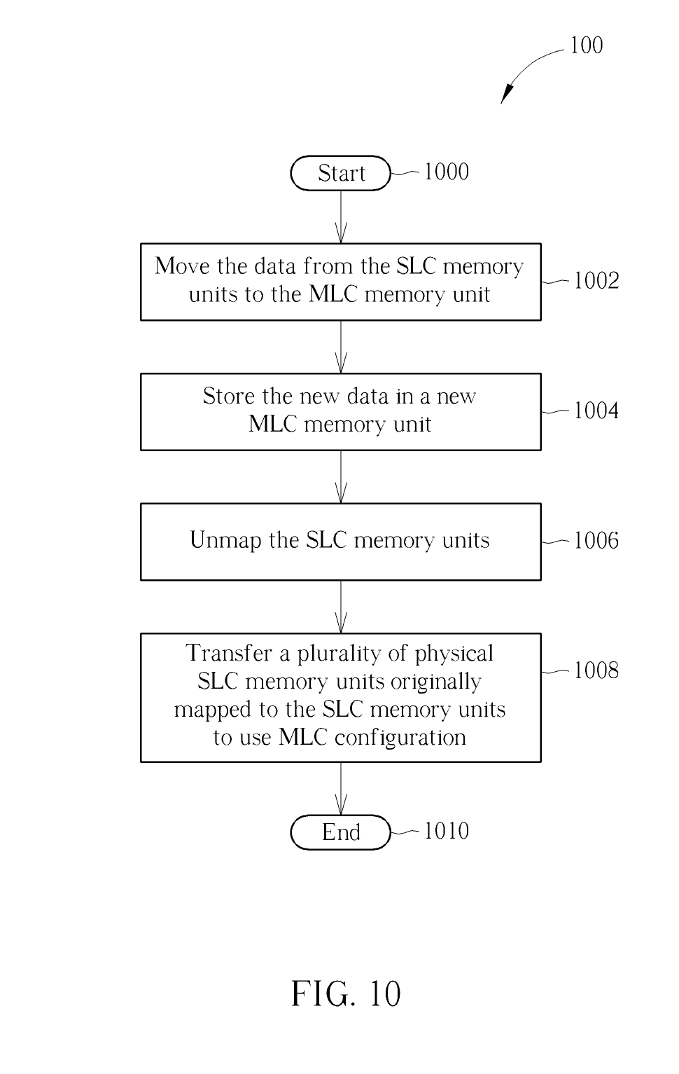

In addition, when the new data is assigned to be stored in the at least one of the plurality of SLC memory units, the memory controller further executes a reallocation process 100, as shown in FIG. 10. The reallocating process 100 includes the following steps:

Step 1000: Start.

Step 1002: Move the data from the SLC memory units to the MLC memory unit.

Step 1004: Store the new data in a new MLC memory unit.

Step 1006: Unmap the SLC memory units.

Step 1008: Transfer a plurality of physical SLC memory units originally mapped to the SLC memory units to use MLC configuration.

Step 1010: End.

When the pre-written data is stored in the MLC memory, a portion of the MLC memory is transferred to an SLC area, which stores the data in SLC configuration. When the data needs to be updated or the SLC memory area is allocated to store new data, the data stored in the SLC area is moved to the MLC memory area, and the SLC memory area will then be transferred to the MLC memory area.

In the prior art, in the mass production flow of the MLC flash memory, there is usually pre-written data stored in the flash memory before the memory chip is soldered on the circuit board. If the pre-written data is written via MLC technology, it will easily be damaged under high temperature during the soldering process. In comparison, the present invention allows the pre-written data to be stored in SLC configuration. After the soldering process is finished, the SLC areas which store the pre-written data in SLC configuration are reallocated to use MLC configuration when an update of data is involved in the memory units related to the pre-written data, so that the reliability of the pre-written data can be enhanced without reducing the storage capacity of the MLC storage device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of accessing data in a multi-layer cell (MLC) memory, comprising:
using single-layer cell (SLC) configuration to transfer a portion of a plurality of memory units in the MLC memory to an SLC area to forma plurality of MLC memory units and a plurality of SLC memory units;
storing data in the plurality of SLC memory units when the data is assigned to be stored in an MLC memory unit;
mapping the MLC memory unit to the SLC memory units;
reading the data by obtaining the data in the SLC memory units corresponding to the MLC memory unit; and
reallocating the SLC memory units to use MLC configuration when an update of data is involved in the MLC memory unit or a new data is assigned to be stored in at least one of the SLC memory units.

2. The method of claim 1, wherein the MLC memory is a triple-level cell (TLC) memory, the MLC memory unit is a TLC memory unit, and the MLC memory unit is mapping to three SLC memory units.

3. The method of claim 1, wherein when the update of data is involved in the MLC memory unit, the method further comprises:
using the MLC memory unit to store the updated data and valid data in the SLC memory units;
unmapping each of the SLC memory units; and
transferring a plurality of physical SLC memory units originally mapped to the SLC memory units to a plurality of physical MLC memory unit by using MLC configuration.

4. The method of claim 1, wherein when the new data is assigned to store in an SLC memory unit among the plurality of SLC memory units, the method further comprises:
moving the data from the SLC memory units to the MLC memory unit;
storing the new data in a new physical MLC memory unit;
unmapping the SLC memory units; and
transferring a plurality of physical SLC memory units originally mapped to the SLC memory units to a plurality of physical MLC memory unit by using MLC configuration.

5. The method of claim 1, further comprising:
using a flag to record memory units in the SLC area which store data in SLC configuration and corresponding memory units in the MLC area; and
recording mapping information related to the memory units in the MLC area corresponding to the memory units in the SLC area.

6. A multi-layer cell (MLC) storage device, comprising:
an MLC memory, comprising a plurality of memory units; and
a memory controller, coupled to the MLC memory, for accessing data in the MLC memory by executing the following steps:
using single-layer cell (SLC) configuration to transfer a portion of the plurality of memory units in the MLC memory to an SLC area to form a plurality of MLC memory units and a plurality of SLC memory units;
storing data in the plurality of SLC memory units when the data is assigned to be stored in an MLC memory unit;
mapping the MLC memory unit to the SLC memory units;
reading the data by obtaining the data in the SLC memory units corresponding to the MLC memory unit; and
reallocating the SLC memory units to use MLC configuration when an update of data is involved in the MLC memory unit or a new data is assigned to be stored in at least one of the SLC memory units.

7. The MLC storage device of claim 6, wherein the MLC memory is a triple-level cell (TLC) memory, the MLC memory unit is a TLC memory unit, and the MLC memory unit is mapping to three SLC memory units.

8. The MLC storage device of claim 6, wherein when the update of data is involved in the MLC memory unit, the memory controller further executes the following steps to access data in the MLC memory:
using the MLC memory unit to store the updated data and valid data in the SLC memory units;
unmapping each of the SLC memory units; and
transferring a plurality of physical SLC memory units originally mapped to the SLC memory units to a plurality of physical MLC memory units by using MLC configuration.

9. The MLC storage device of claim 6, wherein when the new data is assigned to store in an SLC memory unit among the plurality of SLC memory units, the memory controller further executes the following steps to access data in the MLC memory:
moving the data from the SLC memory units to the MLC memory unit;
storing the new data in a new physical MLC memory unit;
unmapping the SLC memory units; and
transferring a plurality of physical SLC memory units originally mapped to the SLC memory units to a plurality of physical MLC memory units by using MLC configuration.

10. The MLC storage device of claim 6, wherein the memory controller further executes the following steps to access data in the MLC memory:
using a flag to record memory units in the SLC area which store data in SLC configuration and corresponding memory units in the MLC area; and
recording mapping information related to the memory units in the MLC area corresponding to the memory units in the SLC area.

11. A method of accessing data in a multi-layer cell (MLC) memory, comprising:
storing data in an SLC memory area by transferring a portion of an MLC memory area in the MLC memory to form the SLC memory area;
moving the stored data from the SLC memory area to the MLC memory area when the SLC memory area is allocated to store a new data or an update of the stored data is involved; and
transferring the SLC memory area to form the portion of MLC memory area.

12. The method of claim 11, wherein the MLC memory is a triple-level cell (TLC) memory.

13. The method of claim 11, wherein when the update of the stored data is involved, the method further comprises:
using the MLC memory area to store the updated data and valid data in the SLC memory area;
unmapping the SLC memory area; and
transferring a physical SLC memory area originally mapped to the SLC memory area to a physical MLC memory area by using MLC configuration.

14. The method of claim 11, wherein when the new data is assigned to store in the SLC memory area, the method further comprises:
moving the data from the SLC memory area to the MLC memory area;
storing the new data in the MLC memory area;
unmapping the SLC memory area; and
transferring a physical SLC memory area originally mapped to the SLC memory area to a physical MLC memory area by using MLC configuration.

15. The method of claim 11, further comprising:
using a flag to record the SLC memory area which store data in SLC configuration and corresponding memory units in the MLC memory area; and
recording mapping information related to the MLC memory area corresponding to the SLC memory area.

16. A multi-layer cell (MLC) storage device, comprising:
an MLC memory, comprising an MLC memory area to store data; and
a memory controller, coupled to the MLC memory, for accessing data in the MLC memory by executing the following steps:
storing data in an SLC memory area by transferring a portion of an MLC memory area in the MLC memory to form the SLC memory area;
moving the stored data from the SLC memory area to the MLC memory area when the SLC memory area is allocated to store a new data or an update of the stored data is involved; and
transferring the SLC memory area to form the portion of MLC memory area.

17. The method of claim 16, wherein the MLC memory is a triple-level cell (TLC) memory.

18. The method of claim 16, wherein when the update of the stored data is involved, the memory controller further executes the following steps to access data in the MLC memory:
using the MLC memory area to store the updated data and valid data in the SLC memory area;
unmapping the SLC memory area; and
transferring a physical SLC memory area originally mapped to the SLC memory area to a physical MLC memory area by using MLC configuration.

19. The method of claim 16, wherein when the new data is assigned to store in the SLC memory area, the memory controller further executes the following steps to access data in the MLC memory:
moving the data from the SLC memory area to the MLC memory area;
storing the new data in the MLC memory area;
unmapping the SLC memory area; and
transferring a physical SLC memory area originally mapped to the SLC memory area to a physical MLC memory area by using MLC configuration.

20. The method of claim 16, wherein the memory controller further executes the following steps to access data in the MLC memory:
using a flag to record the SLC memory area which store data in SLC configuration and corresponding memory units in the MLC memory area; and
recording mapping information related to the MLC memory area corresponding to the SLC memory area.
